(19) United States
(12) Patent Application Publication
(10) Pub. No.: US 2009/0280870 A1
(43) Pub. Date: Nov. 12, 2009

(54) Hands-free unit for a vehicle with an adjustable microphone

(76) Inventors: Jens Muttschall, Schermbeck (DE); Klause-Dieter Mejerling, Eslohe-Reiste (DE)

Correspondence Address: Locke Lord Bissell & Liddell LLP;Attn: IP Docketing, Three World Financial Center, New York, NY, 10281-2101, US

(21) Appl. No.: 11/666,324

(22) PCT Filed: Oct. 25, 2004
(86) PCT No.: PCT/IB04/03484

§ 371 Date: Jul. 29, 2009

(51) Int. Cl. H04M 1/00

(52) U.S. Cl. 455/569.2

(57) ABSTRACT

The invention relates to a hands-free unit for use of communication devices in vehicles which comprises a housing and an interface for connecting a cellular phone which has a directional microphone connected to said interface, wherein said directional microphone is accommodated in said housing.

The present invention relates to the field of hands-free units for cellular phone communication in vehicles. The present invention relates to the field of hands-free units provided with a microphone. It also relates to a solution for hands-free units for vehicles which are available for left and right hand driving installations. More specifically the invention relates to a hands-free units provided with a microphone that can be oriented for use from the drivers and passengers seat.

At present there are different concepts available for hands-free units of vehicles.

Conventionally a vehicle hands-free unit for a cellular phone comprises a cradle to hold a cellular telephone in an easily accessible position to enable taking and making calls. More sophisticated embodiments to state of the art hands-free units are provided with chargers, connections to an onboard power supply and external loudspeakers and microphones.

Such a telephone holder is e.g. disclosed in document EP 0 447 715. In this document a cradle for a car telephone is shown that can be oriented in a direction towards the driver seat or towards the passenger seat. This is achieved by an inclined cradle element that can be coupled in two different positions to the hands-free unit.

Hands-free units have been coupled to an onboard audio system to increase the quality of the audio output and to economize the loudspeaker of the hands-free unit and to prevent that the user/driver has to turn off the radio when receiving a telephone call.

Other embodiments of hands-free units are provided with an external microphone that can be directed to the mouth of a user to increase the quality of audio signals. Such a moveable external microphone mounting arm assembly is e.g. disclosed in document WO96/31994. When using external microphones a cable is required to connect the microphone to the hands-free unit. Due to the high grade of integration in modern vehicles it is nearly impossible to accommodate these additional cables in an unobtrusive way. Conventional hands-free devices with external microphones are usually installed in the center console or the glove box.

Hands-free units have been coupled to onboard audio systems to increase the quality of the audio output and to prevent that the user/driver has to turn off the radio when receiving a telephone call.

All the above approaches for hands-free units for vehicles have in common that they are not fully suitable with the use of mobile terminal devices as mobile phones, or handheld communicators in vehicles and cannot fully enable the use and operation of the hands-free unit from the driver seat as well as from the passenger seat. Therefore, an improved arrangement for a hands-free unit for vehicles is desired that is suitable for right hand side and left hand side driven vehicles. It is also desirable to have a hands-free unit for a vehicle that can be used by the driver and by the passenger. It is also desirable to have a hands-free unit for vehicles with an improved sound and speech pick up system to suppress background noise.

According to a first aspect of the present invention a hands-free unit for use with communication devices in vehicles is provided. The hands-free unit comprises a housing , an interface for connecting a cellular phone and a directional microphone.

The housing can protect the internal parts of the hands-free unit from environmental influences. Additionally, the housing can be designed to fit the design principles of different types of vehicles.

The hands-free unit is provided with an interface for connecting a cellular phone. The expression “cellular phone” is used in the text in the sense of any kind of mobile voice communication means, such as GSM telephones, UMTS mobile phones, i-mode phones, communicators, game phones and the like.

The interface can be e.g. a mechanic interface for mechanically connecting a cellular phone to said housing. This can be embodied as a cradle for a cellular phone. The mechanical interface may be embodied as an adapter for mechanically connecting different kinds or types of cellular phones to said hands-free unit. It may also be mentioned that the interface can be embodied as a connector to electrically connect to said cellular telephone. Such an interface may comprise an electric connector for plugging an adapter or connector cable. It may also be noted that the interface may be incorporated as an air interface for exchanging data e.g. via an infrared and/or a radio communication interface such as e.g. Bluetooth or e.g. W-LAN. It is also envisaged to provide a radio frequency interface to the hands-free unit. By using a radio frequency interface the hands-free device may also serve as a relay station to reduce the radio frequency power emitted inside the vehicle. The radio interface can be embodied as e.g. a near-field air-interface i.e. as a capacitative coupler or as an inductive coupler in said cradle element positioned in close proximity to an antenna structure of a cellular telephone in said cradle.

The directional microphone is connected to said interface for connecting a cellular phone and said directional microphone is accomodated in said housing. The directional microphone is an acousto electric transducer with a directional pick-up characteristic. The expression “directional pick-up characteristic refers to a pick-up characteristic within e.g. one octant, or within an volume of a cone with an angle of maximal 45° degrees between the symmetry axis and the surface of the cone. It is also envisaged to employ a directional microphone with a pick-up characteristic that is not rotationally symmetric or not mirror-symmetric.

The hands-free unit is intended to be installed inside the car and to be visible. This is due to the fact that directional microphones require a nearly unobstructed acoustic path to the position a speaker is expected to be.

In an example embodiment of the present invention said hands-free unit is provided with a main circuit board arranged in said housing. The main circuit board and said directional microphone are accomodated in said housing. Said directional microphone is at least electrically connected to said main circuit board. The main circuit board can comprise e.g. a processing unit, amplifiers and electrical connectors, voltage transformers, power adaptors, fuses, volume controls and indication lights.

In an example embodiment of the present invention said hands-free unit is provided with a component to orient a pick-up characteristic of said microphone in a direction to the driver seat or in a direction to the passenger seat. In a simple embodiment the directional microphone can be mounted e.g. pivotably or movably in said housing. However it may be possible to change only the orientation of the maximum of the angular area with the highest sensitivity of the microphone into the direction of where it is expected that the head of a driver or a passenger is located. That is, this embodiment is enabled to direct the pick-up characteristic approximately to the area of a headrest of the driver seat or passenger seat. This may be achieved by a movable directional microphone, by a movable acoustic system, by two different switchable directional microphones or by a phased array microphone with an adaptive pick-up characteristic.

In another example embodiment of said hands-free unit said directional microphone is orientable. Said orientable directional microphone results in an orientable pick-up characteristic. This may be embodied e.g. as a movable microphone mounted on a slider. A slider might be implemented with a curved slidepath.

In another example embodiment of the present invention the housing of the hands-free unit comprises a first housing component and a second housing component, wherein said main circuit board is arranged in said first housing component and said directional microphone is arranged in said second housing component.

In another example embodiment said second housing component is pivotable around an axis within an angle of at least 90° and not more than 270°. It is also additionally envisaged to implement a pivot angle of substantially 180°. The pivot axis can be a component of the housing or can be an axis of rotation. The pivot axis can be oriented in the horizontal plane of the vehicle when the hands-free unit is installed. It is also contemplated to use a vertical pivot axis. It is also envisaged to orient the pivot axis substantially in the longitudinal direction of the vehicle. In this case it is possible to place e.g. a cradle for a mobile telephone in front of the pivot axis.

The pivotability is used to achieve that the microphone can be aligned optimally in a direction to the driver, in the case of vehicles with steering column at the left side as well as for vehicles with the steering column on the right side. The invention also enables the use of the hands-free device on the left and on the right side of the pilot or driver of the vehicle. This can be a significant advantage for e.g. left-handed drivers of cars with the driver's seat on the left side. In this case the user can touch the hands-free device (or an inserted cellular phone) with the left hand (and vice versa for right handed people in vehicles with the drivers seat on the right side).

In yet another example embodiment of the present invention said pick-up characteristic of said microphone is substantially oriented at an angle between 35° to 75° degrees with respect to said pivot axis. In combination with a pivotability of between 90° and 270° the left and the right section of the passenger compartment can be put into the pick-up area of the directional microphone.

In just another example embodiment said first housing component is provided with a sensor (i.e. a switch) to determine the present pivot position of said pivotable second housing component and said determined pivot position is used to activate the hands-free unit. That is, the hands-free unit is provided with a component to determine the pivot position of the second housing component and to control the operation of the hands-free unit accordingly. It is envisaged to use the pivotable housing component with the microphone as a “select lever” to take a telephone by pivoting the second housing component from an upright or vertical position into a direction to the diver (seat) or in a direction to the passenger (seat). It is also contemplated to provide a cam that can engage a respective notch at the upright position of the second housing component such that said second housing component can repeatedly be brought into a defined upright position. It may be envisaged to enable a movement of the second housing component as known from e.g. steering column switches to enable the second housing component to be moved from the driver's position to the passenger's position without interrupting a telephone call.

In another example embodiment of said hands-free unit said first housing component and said second housing component are both provided with electric interface elements and with mechanic interface elements to detachably connect said first housing component to said second housing component. In this embodiment said first housing component is provided with two of said interface elements and is able to couple said second housing component in a first position or in a second position. When connected to said first interface element said pick-up characteristic of said microphone in said second housing component is oriented in a direction to the driver seat. When coupled to said second interface element of said first housing component said pick-up characteristic of said microphone in said second housing component is oriented in a direction to the passenger seat.

This embodiment provides a simple possibility to avoid the usage of a pivot axis and movable parts. This advantage is achieved by renunciation to the pivotabilty and the ability to change the orientation of the second housing easily. However, this drawback enables the use of cheaper interfaces and more rigid electric components and prevents that e.g. the mechanical pivot connection wears out.

In a simple embodiment the electromechanical interface can be embodied as a first housing component with two sockets (each one directed to the drivers seat and to the passengers seat or the left or the right side of the hands-free unit) and a second housing component with a plug. That is, the second housing component can be plugged into the left or into the right side of the first housing component. If the plug or the sockets are provided with catches or pawls, this electrical connection can also provide the mechanical connection. It is also envisaged to mechanically support the second housing component only through one of said two sockets in the hands-free unit. In case that the socket is round, it is also possible to turn the second housing component by 360°. It is contemplated to use this embodiment with two second housing components and two microphones.

In yet another example embodiment of the hand-free unit said second housing component can be rigidly fixed in one position. It is contemplated to use a second housing component that is movable (turnable or repluggable) at the installation point of time, and can be fixed after the installation in the first or the second position, such that if the hands-free unit has been built in the position of the second housing component can not longer be changed. It is envisaged to enable a user to secure the second housing part in the first or second position i.e. to close the pivotability and/or the pluggability after the installation of the hands-free unit. This embodiment can be used for vehicles with the driver's seat on the right side as well as for vehicles with the driver's seat on the left side.

In another example embodiment of the present invention said hands-free unit comprises a first directional microphone and a second directional microphone. One directional microphone is the first directional microphone and is fixedly oriented in a direction to the driver seat. Said second directional microphone is arranged in said housing and is oriented in a direction to the passenger seat. The hands-free unit of the present embodiment is provided with a circuitry to select said first and/or said second directional microphone as active microphone.

This embodiment allows a kind of operationfree “software solution” to fully avoid the use of movable parts in a vibrating and oscillating vehicle environment. Instead of moving a housing component one of two pre-orientated directional microphones can be selected. In a simple embodiment said circuitry to select said first and/or said second directional microphone as active microphone can be embodied as a switch on top of the housing to simply switch from the first to the second microphone or to both microphones.

In yet another example embodiment of the hands-free unit said circuitry to select said first and/or said second directional microphone as active microphone is connected to respective car sensors determining if the driver seat and/or the passenger seat is occupied, to activate said microphones accordingly. These sensors can be e.g. safety belt buckle switches to determine if the first or the second microphone or both directional microphones are to be activated.

A further example embodiment of the hands-free unit is further provided with an interface to a vehicle bus. This enables a more complex access to different vehicle applications such as accessing car sensors, car interfaces such as keyboards, displays touch screen interfaces. It may be possible to eliminate certain sources of background noise, e.g. by turning off the radio, closing the windows, limiting the rotational speed of the vehicle engine and the like. Other implementations are also envisaged such as an emergency-call automatic in case of e.g. an airbag inflation. It is also possible to power the hands-free unit via the onboard power system to operate the hands-free unit and to charge a battery pack of the cellular phone. Said interface to a vehicle bus can comprise an interface to a vehicle audio system. In the simplest case the vehicle audio system is a car radio and the interface is used to activate the “mute” function of the car radio in case of an incoming telephone call or during a telephone call. More sophisticated embodiments can be provided with an audio output to use the loudspeakers of the car audio system for outputting incoming audio telephone signals. More sophisticated embodiments can use said interface for uploading (or exchanging) audio files to the cellular phone (e.g. as a new ringing tone/tune or for feeding an in-telephone audio player).

In another example embodiment of the hands-free unit said microphone has a lobar pick-up characteristic. This enables the use of conventional directional microphones to reduce costs.

In yet another example embodiment of the hands-free unit said interface for connecting a cellular phone comprises a receptacle for a cellular phone. That is, the hands-free unit is provided with a cradle or a docking station for a mobile terminal device. This embodiment relates to the integration of a microphone into the cradle of a cellular telephone of a hands-free unit of a vehicle.

In yet another example embodiment said hands-fee unit of the present invention further comprises a mechanical interface for connecting a receptacle for a cellular phone. That is, a receptacle for a mobile telephone is connected to said hands-free unit via a mechanical interface. The mechanical interface may also comprise an electrical interface. This enables the use of a single hands-free device for cellular phones of different shape and with differently shaped electric interfaces. However, it is envisaged to use said interface for connecting a cellular phone to plug in an electrical adapter device to respective contacts in said receptacle or cradle. That is, the cradle for the cellular telephone can be provided with contacts to automatically electrically connect to said hands-free unit. It is contemplated to provide a cover to cover the mechanical structures of said interface for connecting a receptacle if no receptacle is connected.

In a further example embodiment said hands-free unit comprises a mechanical interface to a mounting plate for mounting said hands-free unit in different cars. It is also envisaged to provide a combined electromechanical interface to e.g. a power supply or e.g. a vehicle (data and/or audio) bus. That is, the hands-free unit of the present invention can be used in different vehicles. The use of mounting plates has the advantage that the hands-free unit can be built in different kind of cars with a minimum of changes and installation in the car. That is, the mounting plate can be removed without leaving e.g. any visible changes at the vehicle.

In one example embodiment of said hands-free unit said mechanical interface to a mounting plate is complementary to said mechanical interface for connecting a receptacle for a cellular phone. This design enables the hands-free unit to be inserted between respective interfaces of an existing cellular phone receptacle and a mounting plate combination.

The hands-free unit is visibly installed between e.g. the dashboard and the cellular phone receptacle or cradle. The microphone is an integral part of the hands-free unit and the position of the microphone can be moved or turned to either side to improve the audio quality in the up-link direction. The microphone can be made movable to either side, as there are left hand driver cars and right hand driven cars. The complete hands-free unit can be implemented very compact as it should be designed to be as unobtrusive as possible.

In another example embodiment of the present invention said hands-free unit further comprises a cellular telephone receiver and a cellular telephone transmitter. This embodiment can be provided with an external antenna and can serve to keep the passenger free of high frequency radio emissions. It is envisaged to provide e.g. a cellular phone antenna structure in the cradle and to provide an external car antenna to enable a relay-operation of the cellular telephone signal from inside the car to an external antenna.

In another example embodiment of said hands-free unit said interface for connecting a cellular phone comprises a Bluetooth interface for transferring SIM-card information from the cellular phone to the hands-free unit. It is envisaged to transfer SIM-card information from the cellular phone to the hands-free unit. In this embodiment the cellular phone in the vehicle (e.g. in the cradle or via short-range radio transmission such as Bluetooth) provides only SIM-card information to enable a complete cellular phone in the vehicle to operate and make calls. This embodiment can utilize a SIM-Access profile of Bluetooth, to enable the use of SIM card information to operate an onboard cellular telephone transceiver in the car via a high gain external antenna. This enables the use of cellular phones without any restrictions caused by Faraday effect, restricted transmission power or miniaturized antenna structures.

Said hands-free unit can also be provided with an output interface to connect an external loudspeaker. It is also envisaged to implement an internal loudspeaker in the housing of the hands-free unit. In this case it is envisaged to implement an acoustic-feedback suppression in the hands-free unit.

In yet another example embodiment of the invention said hands-free unit is provided with a user interface. User interfaces such as e.g. switches, keypads, displays, touch screens can be used to prevent that a pilot or driver of a vehicle has to use the tiny keyboards and displays of conventional miniaturized cellular phones. It is for example envisaged to implement a user interface element in a cover for a mechanic interface to a cradle for a mobile telephone in case no cradle is mounted.

In yet another additional example embodiment of the present invention said user interface comprises a light emitting diode (LED). The LED can be incorporated in said first housing element. Said LED may also be incorporated in said second housing element, e.g. in close vicinity to said microphone. This light emitting diode can be used to provide a kind of status indication, indication showing e.g. if and when the hands-free unit is connected to a power source. This light emitting diode can provide an operation indication of said microphone showing e.g. if and when the microphone is activated, muted or the hands-free unit is in an voice controlled mode, enabling for example voice dialing. It is contemplated to illuminate the status indication LED in accordance with an ignition switch signal. It is also envisaged to use a mobile telephone in cradle signal to power the status indication in accordance with an ignition switch signal. It is also possible to use a combined LED that can be illuminated, e.g. in orange in case of an activated ignition switch, and wherein the LED may be illuminated, e.g. with a green color when a cellular telephone is connected, and wherein the LED is operated in a flashing mode when an incoming call is received.

In a further example embodiment of the invention said microphone of said hands-free unit is provided with an acoustic lens. The expression “acoustic lens” has been selected to refer to any kind of focusing or defocusing device inserted between the microphone and the expected position of the driver or the passenger.

In case of e.g. a pivotable second housing component, this may be designed in a way that a part of the support unit of the pivotable microphone serves as a focussing acoustic lens, reflector, horn or bell, wherein the microphone is arranged in the focus. This results in a pivotable acoustic reflector to achieve a desired directional characteristic of the microphone. It may also be envisaged to use a fixed microphone and only move or pivot a respective acoustic guidance element. This would enable an implementation of the hands-free unit without any necessity for bendable electric connections or sliding contacts to the microphone.

In the following, the invention will be described in detail by referring to the enclosed drawings in which:

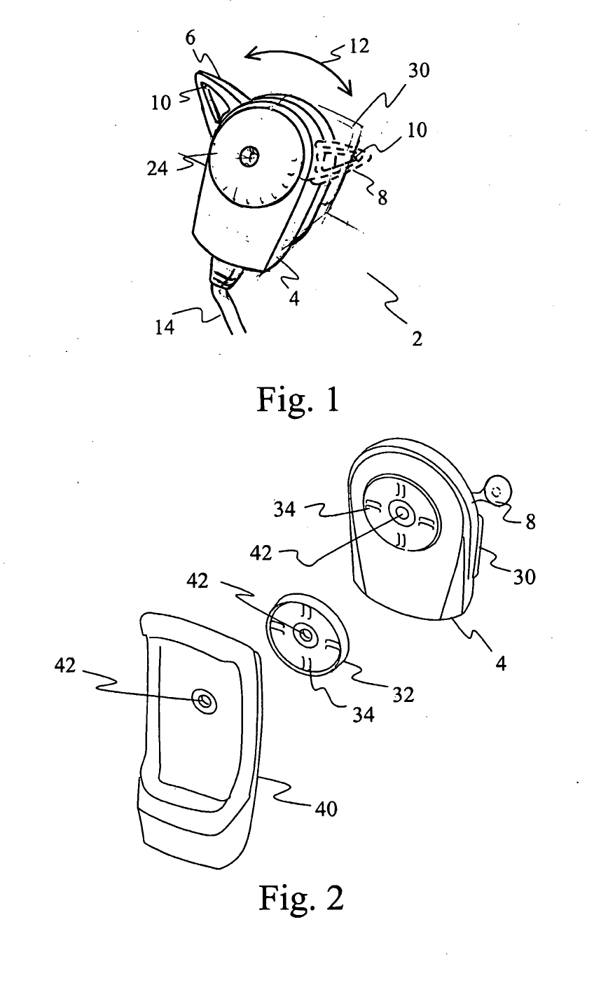

FIG. 1 shows a hands-free unit according to one embodiment of the present invention, and

FIG. 2 depicts another embodiment of a hands-free unit according to the present invention.

In the detailed description that follows, identical or similar components have been given the same reference numerals, regardless of whether they are shown in different embodiments of the present invention. In order to clearly and concisely illustrate the present invention, the drawings may not necessarily be to scale and certain features may be shown in somewhat schematic form.

FIG. 1 shows a hands-free unit according to one embodiment of the present invention. In the figure there is depicted a hands-free unit 2 mounted by a mounting plate or support element 30 on a dashboard indicated by a thin line in the background. The housing of the hands-free unit 2 comprises two different housing components, i.e. the first housing component or main housing 4 and the second housing component or microphone housing 6,8. The microphone housing 6.8 is provided with a microphone 10 behind a sound inlet. In FIG. 1. the microphone housing 6 is depicted in a left position suitable for a mounting position in the middle of a dashboard of a vehicle with the driver seat at the left side. This left position is also suitable for a mounting position between the steering column and the driver door in case of a car with the driver's seat at the right side of the vehicle. The microphone housing 6 can be pivoted or moved in the direction 12 from the left position, to a right position wherein the microphone housing 8 is depicted in broken lines an vice versa.

In FIG. 1 a cable 14 indicates an interface to a mobile telephone or other vehicle appliances. The cable can include e.g. power cable, loudspeaker, car radio (mute switch/audio output), and an ignition signal line. A round structure 24 can be a cover for covering a mechanic interface structure to a cradle for a cellular terminal device. The round structure 24 can be embodied as a button for taking incoming telephone calls or terminating a telephone call.

FIG. 2 depicts another embodiment of a hands-free unit according to the present invention.

FIG. 2 shows a bell-shaped microphone housing 8 in the right position. As in FIG. 1 the main housing 4 can be connected to a surface with the support element 30. The depicted hands-free unit is provided with a mechanic interface with projections 34 and a through hole 42. The mechanic interface of the hands free unit can be used to mount a mobile telephone cradle 40 also provided with a through hole 42 with an adapter ring 32 to the hands-free unit. The adapter ring 32 is also provided with a through hole 42 and projections 34. The backsides of the cradle 40, the adapter ring 32 and the hands-free unit are provided with structures complementary to the structures of the interface visible on the on front side. Thereby, these components can be mounted with a screw at a mounting plate (not depicted) with a respective mechanic interface structure. This enables different “sandwich” structures of the depicted components.

The present invention is applicable in any vehicle environment. The present invention is based on the requirement to decrease the costs of installation of mounting plates. The present invention can be implemented in a highly modular manner wherein a user may select to use an installation kit for only supporting a cellular phone, use e.g. a pre-installed hands-free device of a car or e.g. a car radio equipment, or a hands-free operability of a cellular phone. It is also envisaged to upgrade such a system by adding the hands-free device to an existing mounting plate and cellular phone cradle combination. It is clearly visible that the hands-free unit can be easily removed from a car and may be re-used with another mounting plate in another car and perhaps with another telephone cradle. With the present invention there is no need for a separate microphone, which means lower material costs as well as lower installation costs.

The housing of the hands-free unit can provide a rigid construction without any “swan necks”, it is small and compact to be as invisible as possible and can provide an improved audio hands-free quality due to the movable microphone. The microphone has got a special directional characteristic that can be pointed directly to the user i.e. the pilot/driver, co-pilot or passenger.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. An apparatus, comprising:
a housing;
an interface for connecting a cellular phone; and
a directional microphone connected to said interface, wherein said directional microphone is accommodated in said housing.

2. An apparatus according to claim 1 further comprising a main circuit board arranged in said housing, and wherein said directional microphone is connected to said main circuit board.

3. An apparatus according to claim 1, further comprising a component to orient a pickup characteristic of said microphone in a direction towards a driver's seat or in a direction towards a passenger's seat.

4. An apparatus according to claim 3, wherein said directional microphone is orientable.

5. An apparatus according to claim 2, wherein said housing comprises a first housing component and a second housing component, wherein said main circuit board is accommodated in said first housing component, and said directional microphone is accommodated in said second housing component.

6. An apparatus according to claim 5, wherein said second housing component is pivotable around an axis within an angle of between 90 and 270 degrees.

7. An apparatus according to claim 6, wherein a pick-up characteristic of said microphone is substantially oriented at an angle between 35 to 75 degrees with respect to said pivot axis.

8. An apparatus according to claim 6, wherein said first housing component is provided with a sensor to determine a pivot position of said pivotable second housing component, and wherein said determined pivot position is used to activate the apparatus.

9. An apparatus according to claim 5, wherein said first housing component and said second housing component are both provided with electric and mechanic interface elements to detachably connect said first housing component to said second housing component, said first housing component being provided with two of said interface elements to connect said first housing component in a first position or in a second position, and
wherein in said first position a pick-up characteristic of said microphone in said second housing component is oriented in a direction towards a driver's seat and in said second position said pick-up characteristic of said microphone in said second housing component is oriented in a direction towards a passenger's seat.

10. An apparatus according to claim 5, wherein said second housing component can be rigidly fixed in one position.

11. An apparatus according to claim 1, wherein
said directional microphone is a first directional microphone being fixedly oriented in a direction to a driver seat,
said apparatus being provided with a second directional microphone arranged in said housing oriented in a direction to a passenger seat, and
wherein said apparatus is provided with a circuitry to select said first and/or said second directional microphone as an active microphone.

12. An apparatus according to claim 11, wherein said circuitry to select said first and/or said second directional microphone as an active microphone is connected to respective vehicle sensors for determining if the driver seat and/or the passenger seat is occupied, to activate said microphones accordingly.

13. An apparatus according to claim 1, further comprising an interface to a vehicle bus.

14. An apparatus according to claim 1, wherein said microphone has a lobar pick-up characteristic.

15. An apparatus according to claim 1, wherein said interface for connecting a cellular phone comprises a receptacle for a cellular phone.

16. An apparatus according to claim 1, further comprising a mechanical interface for connecting a receptacle for a cellular phone.

17. An apparatus according to claim 1, further comprising a mechanical interface to a mounting plate for mounting said apparatus in a vehicle.

18. An apparatus according to claim 17 further comprising a mechanical interface for connecting a receptacle for a cellular phone, wherein said mechanical interface to a mounting plate is complementary to said mechanical interface for connecting a receptacle for a cellular phone.

19. An apparatus according to claim 1, further comprising a cellular telephone receiver and a cellular telephone transmitter.

20. An apparatus according to claim 19, wherein said interface for connecting a cellular phone comprises a short-range wireless interface for transferring subscriber identity module card information from the cellular phone to the apparatus.

21. An apparatus according to claim 1, further comprising a user interface.

22. An apparatus according to 21, wherein said user interface comprises a light emitting diode.

23. An apparatus according to claim 1, wherein said microphone is provided with an acoustic lens.

24. An apparatus according to claim 20, wherein said short-range wireless interface is a Bluetooth interface.

25. An apparatus according to claim 1, wherein the apparatus is a hands-free unit for use of communication devices in vehicles.
